(19) United States
(12) Patent Application Publication
(10) Pub. No.: US 2025/0256225 A1
(43) Pub. Date: Aug. 14, 2025

(54) FILTER WITH FILTER MEDIA SETS WHICH ARE ARRANGED IN A V-SHAPED MANNER AND A FRAME

(71) Applicant: Carl Freudenberg KG, Weinheim (DE)

(72) Inventors: Patrick WEBER, Weinheim (DE); Sascha SCHUMACHER, Wald-Michelbach (DE)

(21) Appl. No.: 19/050,183

(22) Filed: Feb. 11, 2025

(30) Foreign Application Priority Data
Feb. 12, 2024 (EP) 24157132.2

(51) Int. Cl. B01D 27/08; B01D 46/121; B01D 46/24

(52) U.S. Cl. CPC B01D 27/08; B01D 46/121; B01D 46/2411

(57) ABSTRACT

A cartridge filter for filtering an air flow, including a plurality of filter media sets including a pair of filter media sets arranged in a V-shape and a frame for receiving the filter media sets. The frame has an inflow-side upper frame, two side plates, and a plurality of outflow-side base plate cross-members. A base plate cross-member is associated with the pair of filter media sets arranged in the V-shape. The cartridge filter further includes protective grids. Each protective grid is associated with a respective filter media set of the plurality of filter media sets at a clean gas side. The protective grids associated with the pair of filter media sets and the base plate cross-member form a structural unit.

### CROSS REFERENCE TO RELATED APPLICATIONS

This application claims benefit to European Patent Application No. EP 24157132.2, filed on Feb. 12, 2024, which is hereby incorporated by reference herein.

### FIELD

The invention relates to a cartridge filter having a plurality of filter media sets.

### BACKGROUND

In gas turbines, compressors, air-conditioning and ventilation installations, extremely different filters are used for cleaning air supply flows, for example, cartridge filters.

EP 3 831 461 A1 discloses such a cartridge filter having a plurality of filter media sets, wherein two filter media sets are arranged in a V-shaped manner and a gas flows through the filter media sets from an unprocessed gas side of the filter to a clean gas side of the filter in order to clean it. Such filters are also referred to as V-cell filters or as V-bank filters. The filter has a frame for receiving the filter media sets with protective grids for the filter medium, wherein a protective grid is arranged in each case at the clean gas side on a respective filter media set.

Such protective grids are also referred to as burst-proof grids. As a result of the protective grid, the filter medium can be fixed in its position and be protected from impairment and damage, in particular during assembly and operation. As a result of the protective grid, parts of the filter medium are prevented from being released and reaching subsequent systems and being able to cause damage there, such as, for example, in gas turbines.

The disadvantage of this filter is the complex assembly of a plurality of individual components and the resulting challenges in the force path configuration as a result of the large number of components.

A filter having a similar structure is set out in US 2014 096493 A1 and U.S. Pat. No. 9,737,838 B2.

Such a filter can be inserted in the manner of a drawer into a rectangular compartment of a filter receiving member. With support faces of the upper frame, the filter then abuts the filter receiving member and can be connected thereto, for example, by means of screwing. It is conventional for a filter receiving member to have a plurality of compartments in order to be able to receive a corresponding plurality of filters which are then arranged in the manner of a matrix and form a so-called filter wall.

Forces acting on the components of the filter during operation of the filter are discharged via the upper frame into the filter receiving member having the drawers and a carrier construction. Forces acting on the elements of the filter itself require the elements of the filter to be well connected to each other, for example, adhesively bonded. The disadvantage of these known filters is their complex configuration of the connection of the frame elements and the protective grids and structural space required for this purpose. High forces act in particular on the connection seams made of casting compound during operation of the cartridge filter. Particularly the protective grids must be well secured so that they perform their function. To this end, a large quantity of casting compound is generally used. The disadvantage is that a degree of instability or lack of strength of the filter remains. Should deformations or breakages occur, occurrences of non-tightness may arise and a leakage occurs during operation.

### SUMMARY

In an embodiment, the present disclosure provides a cartridge filter for filtering an air flow, comprising a plurality of filter media sets comprising a pair of filter media sets arranged in a V-shape and a frame for receiving the filter media sets. The frame has an inflow-side upper frame, two side plates, and a plurality of outflow-side base plate cross-members. A base plate cross-member is associated with the pair of filter media sets arranged in the V-shape. The cartridge filter further comprises protective grids. Each protective grid is associated with a respective filter media set of the plurality of filter media sets at a clean gas side. The protective grids associated with the pair of filter media sets and the base plate cross-member form a structural unit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b show a filter in two views;

FIG. 2 shows an exploded illustration of a filter;

FIGS. 3a-3c show a structural unit comprising two components;

FIG. 4 shows a structural unit comprising only one component; and

FIG. 5 shows a variant of the structural unit from FIGS. 3a-3c.

### DETAILED DESCRIPTION

In an embodiment, the present disclosure provides a cartridge filter, the frame of which has a structure which is simple, stable and advantageous in technical production terms.

In an embodiment, the present disclosure also provides a cartridge filter having a frame which has an optimized connection security.

According to an embodiment, it has been recognized to be advantageous for a cartridge filter to be formed from only a few elements which can be connected to each other in a simple manner during assembly of the filter, which have a good force path through the filter and which ensure a high degree of stability of the filter.

An embodiment provides a cartridge filter having a plurality of filter media sets, wherein two filter media sets are always arranged in pairs in a V-shaped manner at an acute angle with respect to each other, and having a frame for receiving the filter media sets. Such a filter is also referred to as a V-cell filter or as a V-bank filter. A gas, in particular air, flows through the filter media sets from an unprocessed gas side of the filter to a clean gas side of the filter in a main throughflow direction (throughflow direction for short) in order to clean it.

The frame has an inflow-side upper frame, two side plates and a plurality of outflow-side base plate cross-members, wherein a base plate cross-member is associated with a respective pair of filter media sets which are arranged in a V-shaped manner. In addition, the filter has protective grids in order to securely fix the filter media sets in their position during operation of the cartridge filter, wherein a filter media set is associated in each case with a protective grid at the clean gas side. The filter media sets can, for example, have bellows made of pleated filter medium.

According to an embodiment, the protective grids which are associated with a respective pair of filter media sets and the associated base plate cross-member form a structural unit.

A protective grid in this instance is intended to refer to a support structure having at least one web which extends in the longitudinal direction and at least one web which extends in the transverse direction of the protective grid. The support structure prevents components of the filter media sets from potentially being released during operation and causing destruction in systems which are arranged downstream of the cartridge filter at the clean glass side. Such a protective grid can, for example, be configured in a rake-like, comb-like, net-like, in particular spider's-web-like, fence-like or grid-like manner. The term “structural unit” does not necessarily mean that both the protective grids and the base plate cross-member of a structural unit are also configured in an integral and materially uniform manner. The functions of the two protective grids and the base plate cross-member are in each case integrated in a structural unit. The two protective grids and the base plate cross-member of a structural unit are, however, connected to each other in such a manner that during the production of the frame of the cartridge filter they can be combined as a component with the additional elements to form a frame.

Such a frame advantageously has a simple structure which is favorable in terms of technical production. Since the protective grids-as conventional in the prior art-do not have to be adhesively bonded to the base plate cross-members, the base plate cross-members can be configured in a narrow manner. This has a positive effect on the flow resistance of the cartridge filter. Since the protective grid and the base plate cross-member form a structural unit, the respective transition from the protective grids to the base plate cross-member can be configured in a materially uniform manner so that the transition—in contrast to the prior art—no longer forms a weak location and instead is optimized in terms of the flow path. In the region of the transition, there is consequently a higher bending stiffness.

It is also advantageous that the quantity of casting compound required in the production of the cartridge filter can be reduced since the protective grids do not have to be cast with components of the frame which receive them. The casting compound used then only has the objective of connecting the filter media sets to the frame.

On the frame, no structural space for receiving the protective grids also has to be provided so that—with the same dimensions of the cartridge filter—the height of the filter media sets can be increased and consequently the filtration can be improved. In the case of filter media sets with a pleated filter medium, the fold height can be increased and consequently the effective filter surface-area can be increased.

In an advantageous embodiment of the cartridge filter, the respective structural unit comprises two components. They are simpler to produce in technical production terms than a single-piece configuration of the structural unit. The two components are configured in such a manner that they can be and are connected in a simple manner in technical production terms to form the structural unit. In an embodiment, the structural units are configured in an integral and materially uniform manner.

In an embodiment, the two components of a respective structural unit are connected to each other in a positive-locking manner. This is advantageous since the requirement for casting compound can thus be further reduced and a particularly stable connection is provided.

In an embodiment, a respective component of a respective structural unit has in the cross section thereof an L-shape having two legs and the respective component has two faces which are arranged at an angle with respect to each other. The two L-shaped components of a structural unit together form a U-shape, that is to say: the structural unit has a U-shape. The structural unit is consequently in the form of a channel and can receive casting compound. The casting compound which, inter alia, connects the filter media sets to the structural unit, that is to say, adhesively bonds, can additionally also provide a cohesively bonded connection of the two components of a respective structural unit.

In an aspect, the shorter legs of the two components together form a base plate cross-member and the longer leg in each case forms a protective grid. As a result of this specific configuration, an embodiment is disclosed in which the transition from a protective grid to the base plate cross-member is materially uniform with no joint and is consequently optimized in terms of the force path.

In an aspect, the components of a respective structural unit are in abutment against each other with abutting edges of the shortest legs thereof and the abutting edges are formed to complement each other and provided in the longitudinal direction along the abutting edge with a profile. As a result of the two complementary abutting edges, a positive-locking connection of the two components can be achieved in a particularly elegant manner in technical production terms.

The abutting edges can in this instance be configured in a labyrinth-like manner and form a labyrinth seal so that a tight, casting-compatible channel is formed.

Additionally or alternatively, in the region of the abutting edges, locking projections and locking pockets or locking flaps can be configured. Locking projections and locking pockets or locking flaps are in this instance in the form of clip-fit connections with locking mechanisms so that the two components can be locked together and thus connected in a particularly simple, precise and rapid manner.

In an embodiment, the two components of a respective structural unit are in the form of identical components. A particularly cost-effective production of the structural unit is thus enabled. With a complementary configuration of the profile of the abutting edges, they are point-symmetrical, wherein the center of symmetry is located at the center of the base plate cross-member.

In an aspect of the cartridge filter, the base plate cross-members are provided with reinforcement elements which extend from one protective grid of the structural unit to the other protective grid of the structural unit, for example, the material of the structural unit in the region of the reinforcement elements can have a greater thickness. The base plate cross-members are, as a result of the forces acting on the protective grid, exposed to a bending stress during operation of the cartridge filter. As a result of the reinforcement elements, a bending open of the structural unit can advantageously be counteracted.

In an advantageous aspect, the protective grids have a grid structure with a plurality of closed curves of different sizes which are centrally arranged around at least one center of the protective grid, for example, concentrically annular curves, and have a large number of connectors which are orientated radially with respect to the center of the protective grid and which connect the closed curves to each other. Both the curves and the connectors form the webs of the protective grid. The protective grids consequently have a spider's-web-like grid structure.

Advantageously, as a result of this grid structure, forces acting on the protective grid can be distributed in an effective and uniform manner and subsequently discharged into the frame of the cartridge filter. In other words: as a result of such an embodiment of the protective grid provided by the present disclosure, there is a more uniform force distribution over all four sides of the frame, which brings about a more homogeneous stress distribution in the protective grid and consequently enables, for example, narrower structures of the webs with the same functionality.

The term “closed curves” is intended to be understood in this instance to mean that the curves can have small interruptions at some locations. The curves are thus not in the mathematical sense consistent or coherent, but form a web of the grid structure which is characterized by a closed extent around the center of the protective grid.

Calculations have shown that the individual interruptions in the closed curves, in particular also in the edge regions of the protective grid, do not have an unfavorable effect on the stability of the protective grid. For the precise and further configuration, reference is hereby made to DE 10 2022 117 649 in its entirety.

Embodiments described and the described advantageous aspects of the present disclosure also constitute in combination with each other—as long as this is technically advantageous—advantageous further aspects of the present disclosure.

Embodiments are intended to be explained in greater detail with reference to appended exemplary Figures. Elements and components which correspond to each other are given the same reference numerals in the Figures. For the sake of greater clarity of the Figures, illustrations are not true to scale.

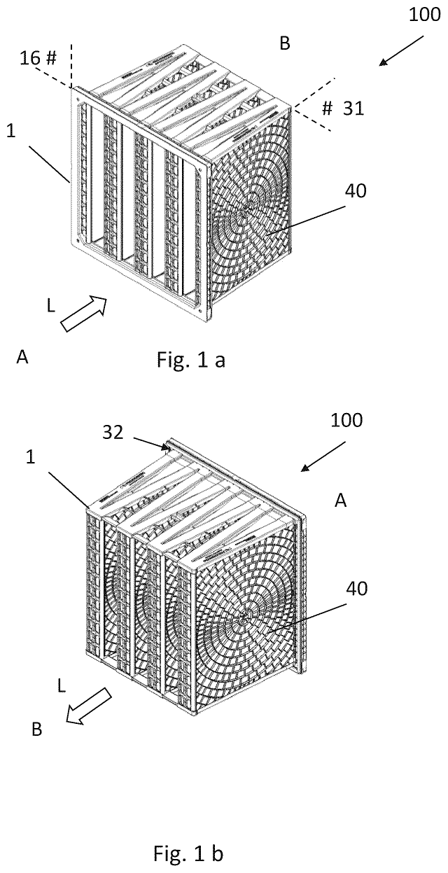

FIGS. 1a and b show a cartridge filter 100 according to an embodiment in two perspective views.

The cartridge filter 100 has eight filter media sets 2 which can be formed from pleated filter medium. Each two filter media sets 2 are always arranged in pairs in a V-shaped manner at an acute angle with respect to each other. A gas flows through the filter media sets 2 from an unprocessed gas side A of the filter 100 to a clean gas side B of the filter 100 in the throughflow direction L in order to clean it.

FIG. 1a shows the filter 100 from the unprocessed gas side A and FIG. 1b shows it from the clean gas side B.

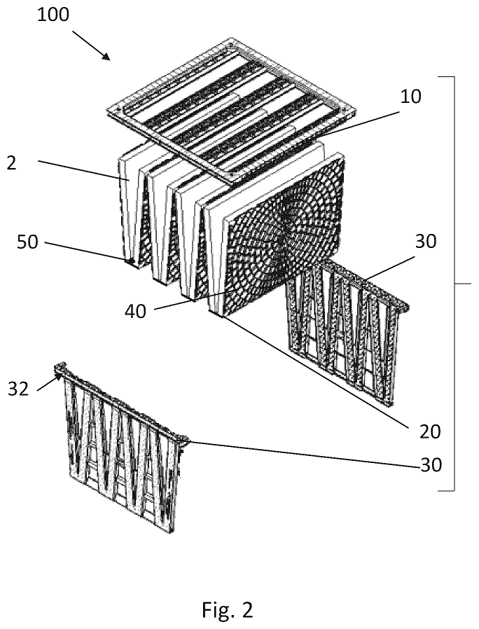

In order to receive the filter media sets 2, a frame 1 is provided. The structure of the frame 1 can be seen in greater detail in FIG. 2. FIG. 1a indicates the plane 16 in which the upper frame is located and the plane 31 in which the side plate 30 (located at the top in the image) is located.

A protective grid 40 is arranged in each case at the clean gas side (A) on a respective filter medium set 2. As a result of the protective grid 40, the filter medium of the filter media sets 2 is fixed in its position and protected from impairment, and subsequent installations are protected from damage. In the embodiment illustrated, two protective grids 40 together with a base plate cross-member 20 form a structural unit 24. It can be in one piece or in several pieces as an injection-molded component.

FIG. 2 shows an exploded illustration of a cartridge filter 100 in an embodiment according to present disclosure and the structure of the frame 1. The frame 1 has an upper plate 10 with a plurality of cross-members and base plate cross-members 20 which are arranged parallel therewith and side plates 30 which are arranged therebetween and perpendicularly thereto. The filter media sets 2 are arranged between the upper plate 10, base plate cross-members 20 and side plates 30, protected at the clean gas side by means of protective grids 40 and received in the frame 1. Two protective grids 40 which are associated with a pair of filter media sets 2 form together with the associated base plate cross-member 20 a structural unit 24. The filter media sets 2 can be connected by means of casting compound 5 to the structural units 24 in a cohesively bonded manner.

The filter 100 can be inserted in the manner of a drawer into a rectangular compartment of a filter receiving member. With support faces of the upper frame 10 on the shoulder 32, the filter 100 then abuts the filter receiving member and can be connected thereto, for example, by means of screwing. It is also provided for a filter receiving member to have a plurality of compartments in order to be able to receive a corresponding plurality of filters 100 which are then arranged in the manner of a matrix and form a so-called filter wall.

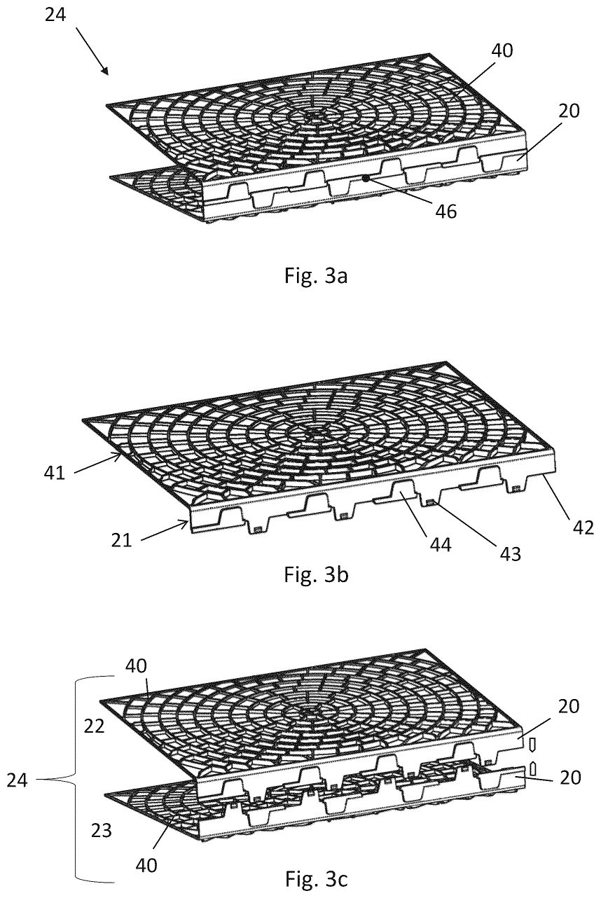

FIGS. 3a to 3c show a structural unit 24 comprising two components 22, 23, wherein the two components 22, 23 are connected to each other in a positive-locking manner. FIG. 3a shows the structural unit 24, FIG. 3b shows one of the two components 22, 23 and FIG. 3c shows how the two components 22, 23 are assembled to form the structural unit 24.

A respective component 22, 23 has in the cross section thereof an L-shape with two legs 21, 41 and the component 22, 23 has two faces which are arranged at an angle with respect to each other in each case. The shorter legs 21 of the two components 22, 23 together form a base plate cross-member 20 and the longer member 41 in each case forms a protective grid 40.

The components 22, 23 are in abutment against each other with the abutting edges 42 of the shorter legs 21 thereof and the abutting edges 42 are formed to complement each other. In this instance, they have complementary locking projections 43 and locking pockets 44 which engage with each other when the two components are pushed together (cf. arrows in FIG. 3c).

The abutting edges 42 are additionally configured in a labyrinth-like manner and form a labyrinth seal. Such labyrinth seals are generally known to the person skilled in the art from sealing technology, for which reason a detailed description is omitted here.

It should be noted that the two components 22, 23 are in the form of identical components. The profile of the abutting edges 42 is point-symmetrical relative to the center of symmetry 46 which is located at the center of the base plate cross-member.

FIG. 5 shows a variant of the structural unit 24 described above. However, the base plate cross-member 20 is in this instance provided with reinforcement elements 45 which extend from one protective grid 40 of the structural unit 24 to the other protective grid 40 of the structural unit 24.

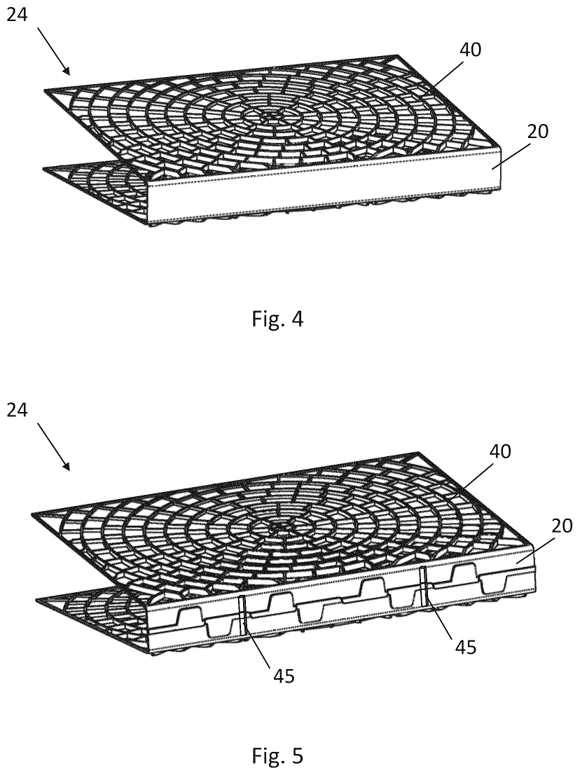

FIG. 4 shows a structural unit 24 comprising only one component.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Frame
2 Filter media set
10 Upper frame
16 Plane of the upper frame
20 Base plate cross-member
21 Shorter leg
22 First component
23 Second component
24 Structural unit
30 Side plate
31 Plane of the side plate
32 Shoulder
40 Protective grid
41 Longer leg
42 Abutting edge
43 Locking projection
44 Locking pocket
45 Reinforcement element
46 Center of symmetry of the profile of the abutting edges
50 Position of casting mass
100 Cartridge filter
A Unprocessed gas side
B Clean gas side
L Throughflow direction

1. A cartridge filter for filtering an air flow, comprising:
a plurality of filter media sets comprising a pair of filter media sets arranged in a V-shape;
a frame for receiving the filter media sets, wherein the frame has:
an inflow-side upper frame,
two side plates, and
a plurality of outflow-side base plate cross-members,
wherein a base plate cross-member is associated with the pair of filter media sets arranged in the V-shape; and
protective grids,
wherein each protective grid is associated with a respective filter media set of the plurality of filter media sets at a clean gas side, and
wherein the protective grids associated with the pair of filter media sets and the base plate cross-member form a structural unit.

2. The cartridge filter as claimed in claim 1, wherein the structural unit comprises two components.

3. The cartridge filter as claimed in claim 2, wherein the two components are connected to each other in a positive-locking manner.

4. The cartridge filter as claimed in claim 2, wherein each of the two components has a cross section of an L-shape having two legs, and each of the two components has two faces arranged at an angle with respect to each other.

5. The cartridge filter as claimed in claim 4, wherein shorter legs of the two legs of each of the two components together form a base plate cross-member and longer legs of the two legs of each of the two components each form a protective grid.

6. The cartridge filter as claimed in claim 5, wherein the two components are in abutment against each other with abutting edges of the shorter legs and the abutting edges are formed to complement each other.

7. The cartridge filter as claimed in claim 6, wherein the abutting edges are configured in a labyrinth-like manner.

8. The cartridge filter as claimed in claim 6, wherein, in a region of the abutting edges, locking projections and locking pockets or locking flaps are configured.

9. The cartridge filter as claimed in claim 2, wherein the two components are identical components.

10. The cartridge filter as claimed in claim 1, wherein the base plate cross-members are provided with reinforcement elements which extend from one protective grid of the structural unit to a second protective grid of the structural unit.

11. The cartridge filter as claimed in claim 1, wherein the protective grids each have a grid structure having closed curves of different sizes, the closed curves being centrally arranged around at least one center of a respective protective grid and having connectors orientated radially with respect to the center of the respective protective grid, the connectors connecting the closed curves to each other.
